(19) United States
(12) Patent Application Publication
(10) Pub. No.: US 2004/0013871 A1
(43) Pub. Date: Jan. 22, 2004

(54) Masking tape for providing decorative edges

(76) Inventor: Stephen S. Pannell, Kennett Square, PA (US)

Correspondence Address: KENNETH A. BENSON, P.O. Box 191, CHATHAM, PA, 19318, US

(21) Appl. No.: 10/198,314

(22) Filed: Jul. 18, 2002

(51) Int. Cl. B32B 9/00

(52) U.S. Cl. 428/343

(57) ABSTRACT

An improved masking tape is provided for use in creating a decorative painted edge on a wall near a joint between said wall and surface protruding along essentially a straight line from the wall such as a ceiling, window frame, or door frame. The masking tape has a patterned edge.

### FIELD OF THE INVENTION

This invention relates to masking tape useful for the easy painting of a decorative edge.

### BACKGROUND

When painting between surfaces using two or more colors, such as between walls and ceilings, walls and moldings, or adjoining walls, painters found that they needed either a steady hand or some type of straight edge in order to make clear sharp lines distinguishing between colors.

Unfortunately not everyone is possessed of a steady hand. More often than not the use of straight edges and paint shields could prove to be awkward. They restrict the use of one hand and are cumbersome in areas such as corners where three or more surfaces meet.

The introduction of masking tape and masking paper in roll form such as described in U.S. Pat. No. 3,032,181 to Hunter (1962) helped to eliminate the above mentioned problems. They offer an easy application and removal of an adhesive straight edge for straight line color separation.

However, these tapes suffer from some disadvantages. The perfectly straight edge of the tape does not allow for possible variations and irregularities formed, for example, when walls and ceilings meet. In some places ceilings may dip down onto wall surfaces and walls may push up into the ceiling. Corners formed in these situations may not be perfectly straight. Tape placed on wall surfaces as described above, where corners are found and while paint is applied to a ceiling, may not adequately protect the wall where it pushes into the ceiling. Masking tape or papers would have to be carefully fitted into non-straight corners thus making the application difficult and time consuming. Furthermore, these tapes tend to buckle and tear when forced into non-straight configurations and may also allow paint to seep under the adhesive edge and mar the surface being protected.

In situations where moldings are to be painted in a color different from the surrounding wall surface, such as a window casement, a great deal of time must be spent masking around the various corners, angles, and possible curves created by the casement. Not only can this be time consuming, but intricate applications around moldings may prove to be tedious.

In addition, masking tapes and papers offer limited color separation. They allow only for the separation of color through the use of a straight line. In some applications of masking tape over long distances, careful measurements must be made in order to create a straight line that does not waver to the naked eye.

U.S. Pat. No. 4,129,669 to Lopez (1978) shows a method of applying decorative designs to surfaces which comprises applying an adhesive stencil to a surface and painting the stencil to form a decorative design on the surface. The stencil is made from a laminated sheet consisting of two layers of waterproof adhesive tapes, each layer containing a plurality of adjacent tapes and the second layer covering the seams in the first layer to form the laminate.

An object of this invention is to provide an improved masking tape, not a stencil, which provides easy formation of a decorative edging on a wall around protrusions from the wall such as window frames, door frames, chair rails, ceilings and the like.

### SUMMARY OF THE INVENTION

The improved masking tape of this invention is a masking tape for use in creating a decorative painted edge on a wall near a joint between the wall and a surface protruding along essentially a straight line from the wall such as a ceiling, window frame, or door frame comprising:

a) a base layer having a front side, a back side, and two longitudinal edges, one of which is a patterned edge having a saw tooth or other repeated pattern; and

b) a continuous adhesive coating on the back side of the base layer extending inwardly from the patterned edge a distance adequate to provide continuous adherence of the patterned edge to the wall.

Optionally, the masking tape may have repeated stencil openings cut through the masking tape near the patterned edge.

The front side of the base layer may have a release coating on it to provide easier unrolling and use of the tape.

In a second embodiment of the invention, the tape may comprise a base layer having a front side, a back side, and two straight longitudinal edges, wherein a patterned edge is partially cut through the center of the base layer so that the edge may be exposed when the tape is attached to the surface to be masked.

A second thin sheet layer may be used in a third embodiment of the invention, wherein the second thin sheet overlayer holds the two longitudinal parts of the base layer together so that the patterned edge may be cut completely through the base layer when it is manufactured.

### BRIEF DESCRIPTION OF DRAWINGS

FIG. 1 shows the masking tape of this invention in its basic form..

FIG. 2 is a second embodiment of the masking tape of this invention showing the use of stencil holes in the tape.

FIG. 3 is a third embodiment of the masking tape of this invention wherein the decorative edge of the tape is perforated and exposed as the tape is applied to a surface.

FIG. 4 is a fourth embodiment of the masking tape of this invention wherein a second film layer is used.

FIG. 5 shows a decorative edge around a window frame and along a wall/ceiling joint easily painted by use of the masking tape of this invention.

### DETAILED DESCRIPTION OF THE PREFERRED EMBODIMENTS

The basic form of the masking tape of this invention is shown in FIG. 1. The tape shown as a roll 1 is comprised of a thin sheet 2 impervious to paint and having a decorative edge 8. The tape has an adhesive 6 on one side of the thin sheet covering enough of the sheet near the decorative edge that the edge may be firmly attached to a surface and prevent the seepage of paint under the decorative edge. The thin sheet may be a plastic, such as a polyester film, or may be any other sheet impervious to paint, such as a paper tape. Optionally, the sheet may have a release coating on the side opposite the adhesive so that the adhesive side may be easily removed from the roll as it is attached to the surface to be painted.

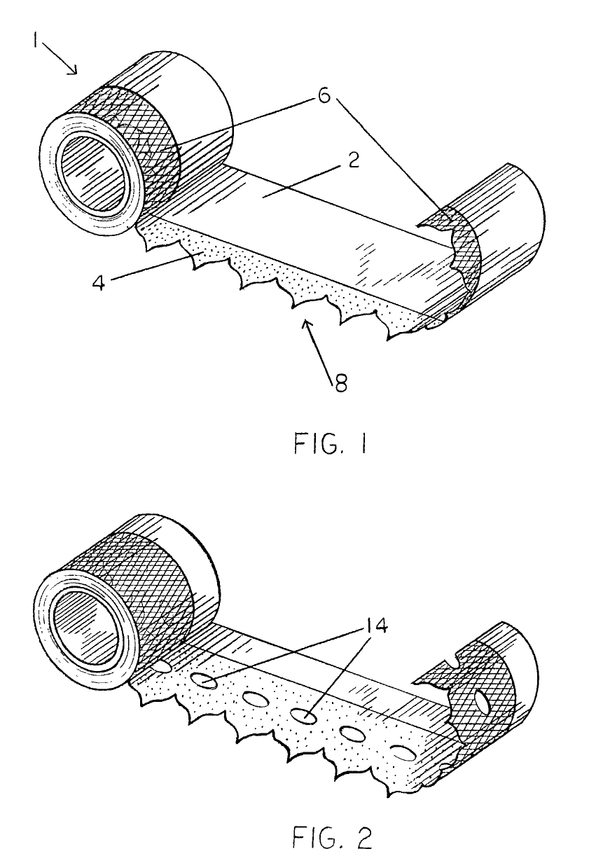

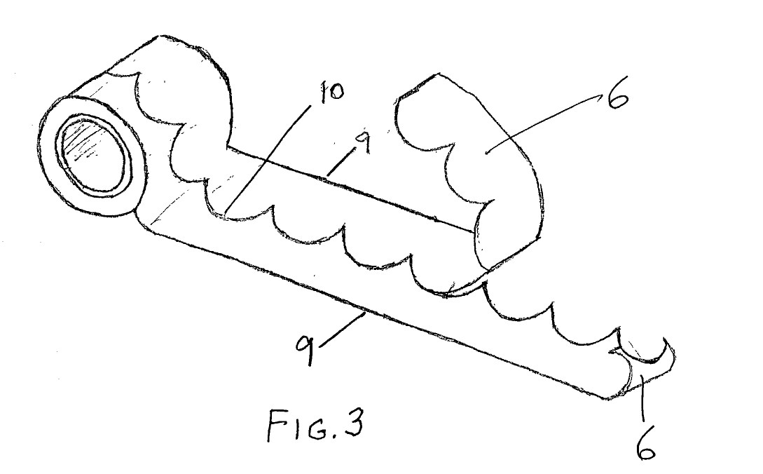

As shown in FIG. 2, in addition to having a decorative edge the tape may have stencil designs shown as oval holes 14. The stencil designs may be of any shape or size as long as the sheet around them is well covered with adhesive and will adhere to the surface to be painted in such a way that no paint will seep under the edge of the stencil hole.

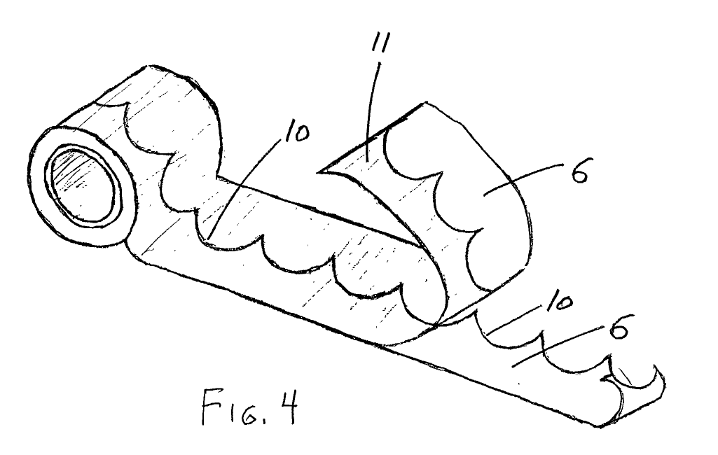

FIG. 3 shows an embodiment of the masking tape of the invention wherein the tape is provided to the user as a roll of tape with two straight sides 9. The decorative edge is a perforated edge 10 that may be exposed by removing one half of the tape either before or after the tape is adhered to the surface to be painted. One may obtain a different decorative edge design depending on which half of the tape is used as a mask on the surface to be painted.

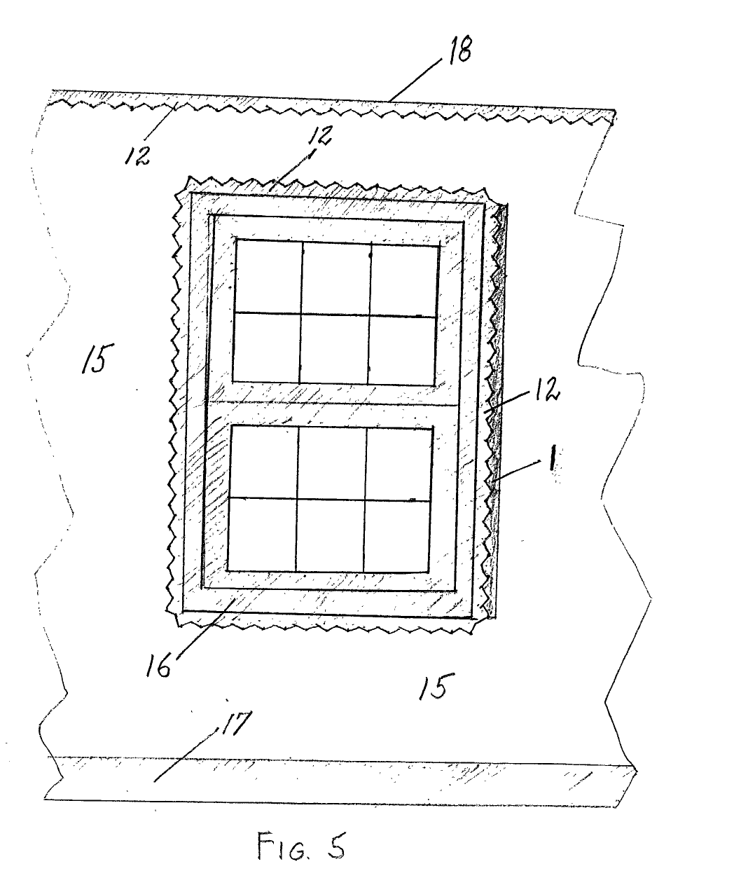

FIG. 4 shows an embodiment of the masking tape of this invention wherein a second thin sheet 11 is placed on top of the masking sheet to protect the cut or perforated decorative edge of the tape before it is applied to the surface to be painted. In this case the decorative edge may be cut completely through the masking tape as it is manufactured allowing an extremely smooth edge to be created. As in the embodiment of FIG. 3, either half of the tape may be used as the mask. Another advantage of using a second sheet is that it may be used in place of a release coating if such is needed with the materials used as the masking sheet and the adhesive.

FIG. 5 shows a decorative edge 12 painted along a wall near the wall joint 18 with a ceiling and around a window frame 16. In this example, the decorative edge 12 is painted the same color as the window frame 16. This is a different color than the wall 15. If it needed painting, the wall 15 would be painted first. Then the masking tape of this invention would be applied to the wall 15 near the window frame 16 to allow the painter to easily apply decorative edge 12. One can see that the decorative edge 12 may replace a molding along the ceiling edge or may be used along with a molding.

The foregoing description is for purposes of illustrating the principles of the invention. Numerous variations and modifications thereof may be apparent to a worker skilled in the art. All such variations and modifications are to be considered to be within the spirit and scope of the invention.

1. Masking tape for use in creating a decorative painted edge on a wall near a joint between said wall and a surface protruding along essentially a straight line from said wall such as a ceiling, window frame, or door frame comprising:
a) a base layer having a front side, a back side, and two longitudinal edges, one of which is a patterned edge having a saw tooth or other repeated pattern; and
b) a continuous adhesive coating on said back side of said base layer extending inwardly from said patterned edge a distance adequate to provide continuous adherence of said patterned edge to said wall.

2. Masking tape according to claim 1 further comprising:
c) a release coating on said front side of said base layer extending about the same distance from said patterned edge as said adhesive coating on said backside of said base layer.

3. Masking tape according to claim 1 wherein a repeated stencil pattern is cut out of said base layer near said patterned edge.

4. Masking tape according to claim 2 wherein a repeated stencil pattern is cut out of said base layer near said patterned edge.

5. Masking tape for use in creating a decorative painted edge on a wall near a joint between said wall and a surface protruding along essentially a straight line from said wall such as a ceiling, window frame, or door frame comprising:
a) a base layer having a front side, a back side, and two straight longitudinal edges, wherein a decorative patterned edge is partially cut through the base layer so that the edge may be exposed when the tape is attached to the surface to be masked; and
b) a continuous adhesive coating on said back side of said base layer extending from said patterned edge a distance adequate to provide continuous adherence of said patterned edge to said wall.

6. Masking tape according to claim 5 further comprising:
c) a release coating on said front side of said base layer extending about the same distance from said patterned edge as said adhesive coating on said backside of said base layer.

7. Masking tape according to claim 5 wherein a repeated stencil pattern is cut out of said base layer near said patterned edge.

8. Masking tape according to claim 6 wherein a repeated stencil pattern is cut out of said base layer near said patterned edge.

9. Masking tape for use in creating a decorative painted edge on a wall near a joint between said wall and a surface protruding along essentially a straight line from said wall such as a ceiling, window frame, or door frame comprising:
a) a base layer having a front side, a back side, and two straight longitudinal edges, wherein a decorative patterned edge is cut through the base layer so that the edge may be exposed when the tape is attached to the surface to be masked;
b) a continuous adhesive coating on said back side of said base layer extending from said patterned edge a distance adequate to provide continuous adherence of said patterned edge to said wall; and
c) a thin sheet overlayer to hold the two longitudinal parts of the base layer together and to be a release sheet for the masking tape.

10. Masking tape according to claim 9 wherein a repeated stencil pattern is cut out of said base layer near said patterned edge.
